(19) United States
(12) Patent Application Publication
(10) Pub. No.: US 2021/0265684 A1
(43) Pub. Date: Aug. 26, 2021

(54) AQUEOUS HEAT TRANSFER SYSTEM, METHOD AND FLUID

(71) Applicant: The Lubrizol Corporation, Wickliffe, OH (US)

(72) Inventors: Mark R. Baker, Greer, SC (US); David M. Pallister, Highland, MI (US); Douglas T. Jayne, Novelty, OH (US); Amy L. Short, Lakewood, OH (US)

(21) Appl. No.: 17/261,728

(22) PCT Filed: Jul. 24, 2019
(86) PCT No.: PCT/US2019/043251

§ 371 Date: Jan. 20, 2021

Related U.S. Application Data
(60) Provisional application No. 62/703,234, filed on Jul. 25, 2018.

(51) Int. Cl. H01M 10/6568; C09K 5/10; H01M 10/613; H01M 10/44

(52) U.S. Cl. CPC H01M 10/6568; H01M 10/443; H01M 10/613; C09K 5/10

(57) ABSTRACT

The disclosed technology relates to a heat transfer system and heat transfer method employing a heat transfer fluid. In particular, the technology relates to an aqueous heat transfer fluid with low electrical conductivity, low flammability, and low freeze point that provides excellent peak temperature reduction in a heat transfer system, such as that for cooling battery modules in electric vehicles.

### BACKGROUND OF THE INVENTION

The disclosed technology relates to a heat transfer system and heat transfer method employing a heat transfer fluid. In particular, the technology relates to an aqueous heat transfer fluid with low electrical conductivity, low flammability, and low freeze point that provides excellent peak temperature reduction in a heat transfer system, such as that for cooling a power system of an electric vehicles.

The operation of a power source generates heat. A heat transfer system, in communication with the power source, regulates the generated heat, and ensures that the power source operates at an optimum temperature. The heat transfer system generally comprises a heat transfer fluid that facilitates absorbing and dissipating the heat from the power source. Heat transfer fluids, which generally consist of water and a glycol, can be expensive and are prone to freezing. Traditional heat transfer fluids can also exhibit extremely high conductivities, often in the range of 3000 micro-siemens per centimeter (μS/cm) or more. This high conductivity produces adverse effects on the heat transfer system by promoting corrosion of metal parts, and also in the case of power sources where the heat transfer system is exposed to an electrical current, such as in fuels cells or the like, the high conductivity can lead to short circuiting of the electrical current and to electrical shock.

Although battery packs are designed to provide high levels of safety and stability, situations can arise where a portion of a battery pack experiences a local thermal condition which generates significant heat. When the temperature is great enough and sustained, the local thermal condition can transform into a runaway thermal condition affecting wide areas of the battery pack, and sometimes the entire battery pack under certain circumstances.

Battery pack designs include an integrated and isolated cooling system that routes coolant throughout the enclosure. When in good working order, the coolant from the cooling system does not come into contact with the electric potentials protected within. It does happen that sometimes a leak occurs and coolant enters into unintended parts of the enclosure. If the coolant is electrically conductive, it can bridge terminals having relatively large potential differences. That bridging may start an electrolysis process in which the coolant is electrolyzed and the coolant will begin to boil when enough energy is conducted into the electrolysis. This boiling can create the local thermal condition that can lead to the runaway thermal condition described above.

A need exists for a heat transfer system and method employing an inexpensive heat transfer fluid with a low electrical conductivity and freeze point.

### SUMMARY OF THE INVENTION

The disclosed technology therefore provides a heat transfer system of a heat transfer fluid circulated in a circulation system in close contact to electrical componentry.

The heat transfer system includes a circulation system to circulate the heat transfer fluid. The circulation system can include, for example, a heat exchanger.

The heat transfer fluid can include water, a C₂ to C₁₈ alkylene glycol, and a soap, such as a C₂ to C₁₈ metal carboxylate or ethanolamine carboxylate, or mixture thereof.

In an embodiment, the water of the heat transfer fluid is demineralized water.

In the same or different embodiment, the C₂ to C₁₈ alkylene glycol can be ethylene glycol or propylene glycol.

In some embodiments, the soap can be disodium adipate or disodium succinate.

In some embodiments, the heat transfer fluid can further include a corrosion inhibitor and/or an antioxidant.

There is also provided a method of dispersing heat from electrical componentry. The method includes providing a heat transfer system in close contact with the electrical componentry. The heat transfer fluid is circulated through the heat transfer system. The electrical componentry is operated and the circulating heat transfer fluid disperses the heat generated by the electrical componentry.

The method of operating the electrical componentry can include employing the electrical componentry to obtain power, such as from a battery module, or charging the electrical componentry (e.g., battery module) to restore its power capacity. In an embodiment, the heat transfer system and method employing the heat transfer fluid can allow the electrical componentry to be charged such that at least 75% of the total power capacity is restored in a time period of less than 15 minutes.

### DETAILED DESCRIPTION OF THE INVENTION

Various preferred features and embodiments will be described below by way of non-limiting illustration.

The present technology includes a heat transfer fluid that provides good heat transfer, is dielectric and has low flammability. The heat transfer fluid itself is a mixture of water, at least one C₂ to C₁₈ alkylene glycol, and a soap.

Preferably the water component is a demineralized water, which would reduce or eliminate the electrical conductivity of the water. Demineralization can be by any known method, such as, for example, by distillation, deionization, reverse osmosis, or filtration. Water may be present in the heat transfer fluid from about 45 to about 80 wt % based on the weight of the heat transfer fluid, or from about 47 to about 75 wt %, or even from about 50 to about 70 wt %.

The C₂ to C₁₈ alkylene glycol can be a diol or triol. The alkylene components can be linear, branched, cyclic or aromatic. Examples of suitable C₂ to C₁₈ alkylene glycols include, for example, ethylene glycol, propylene glycol, 1,3-propanediol, butanediol, bisphenol, resorcinol, glycerin and the like. Other examples can include Sugar alcohols, sorbitol, mannitol, xylitol, erythritol, pentaerythritol, arabitol, inositol, and glycol ethers.

In an embodiment, the C₂ to C₁₈ alkylene glycol can be ethylene glycol. In a further embodiment, the C₂ to C₁₈ alkylene glycol can be propylene glycol. In some embodiments, the C₂ to C₁₈ alkylene glycol can be glycerin. Some embodiments of the C₂ to C₁₈ alkylene glycol can include a combination of glycols, such as propylene glycol and glycerin, or ethylene glycol and glycerin, or even propylene glycol and ethylene glycol. The C₂ to C₁₈ alkylene glycol can be present in the heat transfer fluid at from about 15 to 45 wt % based on the weight of the heat transfer fluid, or from about 20 to about 42 wt %, or from about 25 to about 40 wt %.

The heat transfer fluid also includes a soap. The soap may be at least one of a C₂ to C₁₈ metal carboxylate, or hydrate thereof, or an ethanolamine carboxylate, or mixtures thereof.

Suitable metals for the metal carboxylate salt can include, but are not limited to, alkali or alkaline earth metals, for example, Li, K, Mg, Ca, and Na.

The C₂ to C₁₈ metal carboxylate can be a metal salt of a saturated C₂ to C₁₈ aliphatic carboxylate or di-carboxylate, an unsaturated C₂ to C₁₈ aliphatic carboxylate or di-carboxylate, a saturated C₂ to C₁₈ aliphatic carboxylate or di-carboxylate substituted with at least one OH group, or whose chain is interrupted by at least one oxygen atom (oxyacids), or a cyclic or bicyclic carboxylate or di-carboxylate. In some embodiments, the metal carboxylate can be a C₃ to C₁₈ metal carboxylate, or a C₄ to C₁₈ or C₄ to C₁₆ metal carboxylate, or even a C₆ to C₁₂ metal carboxylate.

Preferably the carboxylate in the C₂ to C₁₈ metal carboxylate is a dicarboxylate. Examples of preferred C₂ to C₁₈ metal carboxylates can include disodium sebacate, disodium dodecanedioate or disodium suberate, and combinations thereof. Other examples of C₂ to C₁₈ metal carboxylates that may be employed include disodium adipate, disodium succinate, disodium azelate, and disodium undecanedioate.

Although dicarboxylates are preferred, monocarboxylates may also be employed, alone or in combination with a dicarboxylate. Examples of monocarboxylates include, for example, formic acid, acetic acid, propionic acid, glycolic acid, lactic acid, lauric acid, stearic acid, and the like. Potassium formate and sodium formate are examples of a C₂ to C₁₈ metal carboxylate.

High carboxylic acids may also be employed, such as, for example, citric acid and the like.

Ethanolamine carboxylates can be employed utilizing the same C₂ to C₁₈ carboxylates mentioned above. In addition, a fatty acid can also be employed to prepare the ethanolamine carboxylate. Ethanolamine fatty acid ester soaps are the reaction product of a mono-, di-, or tri-ethanol amine (i.e., NH₂(CH₂)OH, NH((CH₂)OH)₂, and N((CH₂)OH)₃) with a fatty acid. Suitable fatty acids are not particularly limited, but can include, for example, linolenic acid, stearic acid, palmitoleic acid, oleic acid, erucic acid, butyric acid, caproic acid, caprylic acid, lauric acid, citraconic acid, itaconic acid, palmitic acid and the like. A particular example embodiment can be, for example, mono-, di-, or tri-ethanolamine oleate. Another particular example embodiment can be, for example, mono-, di-, or tri-ethanolamine stearate. An even further particular example embodiment can be, for example, mono, di-, or tri-ethanolamine itaconate.

The soap may be present in the mixture at a sufficient amount to achieve the desired freezing point/heat capacity needed for the environment of the heat transfer. In some instances, the soap may be present in the heat transfer fluid at from about 0.01 to about 15 wt % based on the weight of the heat transfer fluid, or from about 0.05 to about 12 wt %, or even from about 0.1 to about 10 wt %. In some instances the soap may be present in an amount of from about 0.5 to about 5 wt % or 1 to 4 wt %.

In some embodiments, the heat transfer fluid can further comprise a corrosion inhibitor. Non-limiting examples of these additional corrosion inhibitors include fatty acid esters, such as sorbitan fatty acid esters, polyalkylene glycol esters, copolymers of ethylene oxide and propylene oxide, polyoxyalkylene derivatives of sorbitan fatty acid esters, or the like, and combinations thereof. Further examples can include, for example, sodium, potassium and amine salts of neodecanoic acid, dodecanedioic acids, alkyl sarcosines (sodium lauroyl sarcosinate), Alkyl- and alkenyl-succinic acids and their partial esters with alcohols, diols or hydroxycarboxylic acids, and combinations thereof.

The average molecular weight of additional corrosion inhibitors is from about 55 to about 300,000 daltons, and more specifically from about 110 to about 10,000 daltons.

The corrosion inhibitor may be present in the composition from 0.01% to 6.0% or from 0.02%, 0.03%, 0.05%, 0.1% to 6%, 4%, 2%, 1% or even 0.5%.

The heat transfer fluid can also optionally further include an antioxidant.

Any antioxidant that is soluble in water/glycol systems may be employed. Some examples include butylated hydroxytoluene (“BHT”), butylated hydroxy anisole (“BHA”), THBP, TBHQ, 4-hydroxyphenylpropionic acid, propyl gallate, 3,3 thiodipropionic acid, N-phenyl-alpha-naphthylamine (PANA), octylated/butylated diphenylamine, high molecular weight phenolic antioxidants, hindered bis-phenolic antioxidant, di-alpha-tocopherol, di-tertiary butyl phenol and the like, and combinations thereof. The antioxidants may be present in the composition from 0.01% to 6.0% or from 0.02%, 0.03%, 0.05%, 0.1% to 6%, 4%, 2%, 1% or even 0.5%.

The heat transfer fluid may also include a pH buffer system used to keep the pH of the fluid as close to neutral as possible. The fluid can be buffered with various buffers to control the pH variation should the heat transfer fluid be further diluted or contaminated with an acid or base. The buffer can comprise various alkali metal phosphates, borates and carbonates and/or glycines. These include combinations such as sodium phosphate, disodium phosphate, and trisodium phosphate, various borates, glycine, and combinations of sodium bicarbonate and sodium carbonate. The counter ions e.g. sodium, potassium, lithium, calcium, and magnesium are not critical to the buffering and due to the presence of excess potassium may exchange with other cations.

The heat transfer fluid can be employed in a heat transfer system, which would include a circulation system for circulating the heat transfer fluid in close contact to a source of heat, such as electrical componentry. The heat transfer system may include, in one embodiment, a liquid cooling system, that is, a system that can circulate the heat transfer fluid through a heat sink to collect heat from heat generating electrical componentry, and then dissipate the heat, for example, through a liquid-to-air heat exchanger or liquid-to-liquid heat exchanger.

The present technology also provides a method of employing the heat transfer fluid to disperse heat from electrical componentry cooled by a heat transfer system.

The method can include providing an assembly containing electrical componentry requiring cooling. The electrical componentry should be in close contact to the heat transfer system to allow heat generated by the electrical componentry during operation to dissipate into the heat transfer system. The electrical componentry may be operated along with operating the heat transfer system. The heat transfer system may be operated, for example, by circulating the heat transfer fluid through the heat transfer system.

The heat transfer fluid may be suitable for cooling a number of various assemblies having electrical componentry. In some embodiments, the assembly may be an electrified transportation assembly, such as an electric car, truck or even electrified mass transit vehicle, like a train or tram. The main piece of electrical componentry in electrified transportation is often battery modules, which may encompass one or more battery cell stacked relative to one another to construct the battery module. Heat may be generated by each battery cell during charging and discharging operations, or transferred into the battery cells during key-off conditions of the electrified vehicle as a result of relatively extreme (i.e., hot) ambient conditions. The battery module will therefore include a heat transfer system for thermally managing the battery modules over a full range of ambient and/or operating conditions. In fact, operation of battery modules can occur during the use and draining of the power therefrom, such as in the operation of the battery module, or during the charging of the battery module. With regard to charging, the use of the heat transfer fluid can allow the charging of the battery module to at least 75% of the total battery capacity restored in a time period of less than 15 minutes.

Similarly, electrical componentry in electrified transportation can include fuel cells, solar cells, solar panels, photovoltaic cells and the like that require cooling by the heat transfer fluid. Such electrified transportation may also include traditional internal combustion engines as, for example, in a hybrid vehicle.

Electrified transportation may also include electric motors as the electrical componentry. Electric motors may be employed anywhere along the driveline of a vehicle to operate, for example, transmissions, axles and differentials. Such electric motors can be cooled by a heat transfer system employing the heat transfer fluid.

Other assemblies may contain electrical componentry requiring cooling by a heat transfer system with the heat transfer fluid, such as, for example, computers equipment. Computer equipment can include electrical componentry such as computer microprocessors, uninterruptable power supplies (UPSs), power electronics (such as IGBTs, SCRs, thyristers, capacitors, diodes, transistors, rectifiers and the like), and the like.

While several examples of assemblies containing electrical componentry have been provided, the heat transfer fluid may be employed in any assembly or for any electrical componentry to provide an improved heat transfer fluid with cold temperature performance without significantly increasing the electrical conductivity and potential flammability of the mixture when sprayed.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The invention herein is useful for reducing peak temperatures of electrical componentry with a heat transfer fluid characterized by high heat capacity, high thermal conductivity, and low flammability, which may be better understood with reference to the following examples.

### EXAMPLES

Fluid 1 (Comparative)—50/50 water glycol

Fluid 2—a mixture of 32 wt % propylene glycol, 0.59 wt % dipotassium succinate, and the remainder deionized water.

Fluid 3—a mixture of 38.5 wt % propylene glycol, 6 wt % disodium succinate hexahydrate, and the remainder deionized water.

Example 1—A comparison of the heat transfer fluids 1 to 3 using a 1D Cruise™ M computer vehicle simulation platform from AVL List GmbH in a state of the art cooling channel model. The battery model consisted of two battery modules connected in series with respect to both electrical and hydraulic flow. The fluids were compared under simulated constant coolant mass flow (coolant open loop) conditions, using a case scenario of maximal battery depletion and a battery end of life (EOL) model. In this model, the simulated battery system began under a state of charge (SOC) of 95% at a start temperature of 35° C., and proceeded until maximum depletion at a SOC of 20% was reached.

The fluids were tested for absolute and relative comparison of cooling performance in maximum temperature (T_max), change in temperature between modules (ΔT), thermal conductivity (HTC), change in pressure (Δp), change in temperature of the fluid (ΔT_coolant). Further properties, including friction coefficient, heat transfer coefficient (HTC), and coolant channel heat flow were also determined. Fluid 1 and Fluid 2 both demonstrated a uniform HTC over the range of simulated fluid flow rates (0.2-0.3 kg/min) over a 1 h period. During this time, benchmark Fluid 1 produced an average HTC. of 54.445 W/m²/° K. Fluid 2 produced an average HTC of 78.26 W/m²/° K under identical simulation conditions, representing a 44% performance improvement compared to Fluid 1. Further data is described below in Table 1.

TABLE 1

| | | | | | | Maximum value | | |
|---|---|---|---|---|---|---|---|---|
| | | Maximum value/value @ end of cycle | | | | | 1^{st} Module, | 2^{nd} Module, |
| | | | | | Δp | ΔT_coolant | coolant | coolant |
| Test Conditions | | | ΔTmax_1^{st} | HTC | (p_inlet − | (outlet − | heat | heat |
| Duration | Cycle | T_max | module | (average) | p_outlet) | inlet) | input | input |
| [s] | — | [° C.] | [° C.] | [W/m\hat{ }2/K] | [kPa] | [° C.] | [W] | [W] |
| 3600 @0.2 kg/s | Fluid 1 | 44.63/38.70 | 2.125/1.844 | 54.455 | 1.769 | 0.25 | 83.98 | 83.54 |
| 3600 @0.25 kg/s | Fluid 1 | 44.43/38.28 | 2.225/1.91 | 54.455 | 2.18 | 0.21 | 87.88 | 87.5 |
| 3600 @0.3 kg/s | Fluid 1 | 44.26/37.92 | 2.307/1.96 | 54.455 | 2.543 | 0.18 | 91.16 | 90.8 |
| 3600 @0.2 kg/s | Fluid 2 | 43.86/37.15 | 2.39/1.957 | 78.26 | 2.39 | 0.25 | 98.15 | 97.61 |
| 3600 @0.25 kg/s | Fluid 2 | 43.65/36.73 | 2.49/2.01 | 78.26 | 2.99 | 0.21 | 101.99 | 101.52 |
| 3600 @0.3 kg/s | Fluid 2 | 43.47/36.39 | 2.57/2.05 | 78.26 | 3.59 | 0.175 | 105.99 | 104.77 |

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

A heat transfer system comprising (a) a heat transfer fluid comprising, (i) water, (ii) C₂-C₁₈ alkylene glycol, and a soap comprising at least one of a C₂-C₁₈ metal carboxylate, ethanolamine carboxylate, or mixtures thereof and a circulation system for circulating the heat transfer fluid in close contact to electrical componentry. The heat transfer system of the previous sentence, wherein the water is demineralized water. The heat transfer system of any previous sentence, wherein the C₂ to C₁₈ alkylene glycol comprises ethylene glycol. The heat transfer system of any previous sentence, wherein the C₂ to C₁₈ alkylene glycol comprises propylene glycol. The heat transfer system of any previous sentence, wherein the C₂ to C₁₈ alkylene glycol comprises 1,3-propanediol. The heat transfer system of any previous sentence, wherein the C₂ to C₁₈ alkylene glycol comprises butanediol. The heat transfer system of any previous sentence, wherein the C₂ to C₁₈ alkylene glycol comprises bisphenol. The heat transfer system of any previous sentence, wherein the C₂ to C₁₈ alkylene glycol comprises resorcinol. The heat transfer system of any previous sentence, wherein the C₂ to C₁₈ alkylene glycol comprises glycerin. The heat transfer system of any previous sentence, wherein the C₂ to C₁₈ alkylene glycol comprises sugar alcohols. The heat transfer system of any previous sentence, wherein the C₂ to C₁₈ alkylene glycol comprises sorbitol. The heat transfer system of any previous sentence, wherein the C₂ to C₁₈ alkylene glycol comprises mannitol. The heat transfer system of any previous sentence, wherein the C₂ to C₁₈ alkylene glycol comprises xylitol. The heat transfer system of any previous sentence, wherein the C₂ to C₁₈ alkylene glycol comprises erythritol. The heat transfer system of any previous sentence, wherein the C₂ to C₁₈ alkylene glycol comprises pentaerythritol. The heat transfer system of any previous sentence, wherein the C₂ to C₁₈ alkylene glycol comprises arabitol. The heat transfer system of any previous sentence, wherein the C₂ to C₁₈ alkylene glycol comprises inositol. The heat transfer system of any previous sentence, wherein the C₂ to C₁₈ alkylene glycol comprises glycol ethers. The heat transfer system of any previous sentence, wherein the C₂ to C₁₈ alkylene glycol is present in the heat transfer fluid at from about 15 to 45 wt % based on the weight of the heat transfer fluid. The heat transfer system of any previous sentence, wherein the C₂ to C₁₈ alkylene glycol is present in the heat transfer fluid at from about 20 to about 42 wt %. The heat transfer system of any previous sentence, wherein the C₂ to C₁₈ alkylene glycol is present in the heat transfer fluid at from about 25 to about 40 wt %. The heat transfer system of any previous sentence, wherein the soap comprises a C₂ to C₁₈ metal carboxylate. The heat transfer system of any previous sentence, wherein the soap comprises a C₃ to C₁₈ metal carboxylate. The heat transfer system of any previous sentence, wherein the soap comprises a C₄ to C₁₈ metal carboxylate. The heat transfer system of any previous sentence, wherein the soap comprises a C₄ to C₁₆ metal carboxylate. The heat transfer system of any previous sentence, wherein the soap comprises a C₆ to C₁₂ metal carboxylate. The heat transfer system of any previous sentence, wherein the soap comprises an aliphatic carboxylate. The heat transfer system of any previous sentence, wherein the soap comprises a cyclic carboxylate. The heat transfer system of any previous sentence, wherein the soap comprises a di-carboxylate. The heat transfer system of any previous sentence, wherein the metal of the metal carboxylate comprises an alkali metal. The heat transfer system of any previous sentence, wherein the metal of the metal carboxylate comprises Li. The heat transfer system of any previous sentence, wherein the metal of the metal carboxylate comprises Na. The heat transfer system of any previous sentence, wherein the metal of the metal carboxylate comprises K. The heat transfer system of any previous sentence, wherein the metal of the metal carboxylate comprises an alkaline earth metal. The heat transfer system of any previous sentence, wherein the metal of the metal carboxylate comprises Mg. The heat transfer system of any previous sentence, wherein the metal of the metal carboxylate comprises Ca. The heat transfer system of any previous sentence, wherein the soap comprises disodium adipate. The heat transfer system of any previous sentence, wherein the soap comprises disodium succinate. The heat transfer system of any previous sentence, wherein the soap comprises disodium sebacate. The heat transfer system of any previous sentence, wherein the soap comprises disodium dodecanedioate. The heat transfer system of any previous sentence, wherein the soap comprises disodium suberate. The heat transfer system of any previous sentence, wherein the soap comprises disodium azelate. The heat transfer system of any previous sentence, wherein the soap comprises disodium undecanedioate. The heat transfer system of any previous sentence, wherein the soap comprises a formate. The heat transfer system of any previous sentence, wherein the soap comprises acetate. The heat transfer system of any previous sentence, wherein the soap comprises a propionate. The heat transfer system of any previous sentence, wherein the soap comprises a glycolate. The heat transfer system of any previous sentence, wherein the soap comprises a lactate. The heat transfer system of any previous sentence, wherein the soap comprises a laurate. The heat transfer system of any previous sentence, wherein the soap comprises a stearate. The heat transfer system of any previous sentence, wherein the soap comprises an ethanolamine carboxylate. The heat transfer system of any previous sentence, wherein the soap comprises a mono-ethanolamine carboxylate. The heat transfer system of any previous sentence, wherein the soap comprises a di-ethanolamine carboxylate. The heat transfer system of any previous sentence, wherein the soap comprises a tri-ethanolamine carboxylate. The heat transfer system of any previous sentence, wherein the soap comprises an ethanolamine carboxylate, where the fatty acid comprises a linolenic acid. The heat transfer system of any previous sentence, wherein the soap comprises an ethanolamine carboxylate, where the fatty acid comprises a stearic acid. The heat transfer system of any previous sentence, wherein the soap comprises an ethanolamine carboxylate, where the fatty acid comprises a palmitoleic acid. The heat transfer system of any previous sentence, wherein the soap comprises an ethanolamine carboxylate, where the fatty acid comprises a oleic acid. The heat transfer system of any previous sentence, wherein the soap comprises an ethanolamine carboxylate, where the fatty acid comprises a erucic acid. The heat transfer system of any previous sentence, wherein the soap comprises an ethanolamine carboxylate, where the fatty acid comprises a butyric acid. The heat transfer system of any previous sentence, wherein the soap comprises an ethanolamine carboxylate, where the fatty acid comprises a caproic acid. The heat transfer system of any previous sentence, wherein the soap comprises an ethanolamine carboxylate, where the fatty acid comprises a caprylic acid. The heat transfer system of any previous sentence, wherein the soap comprises an ethanolamine carboxylate, where the fatty acid comprises a lauric acid. The heat transfer system of any previous sentence, wherein the soap comprises an ethanolamine carboxylate, where the fatty acid comprises a citraconic acid. The heat transfer system of any previous sentence, wherein the soap comprises an ethanolamine carboxylate, where the fatty acid comprises an itaconic acid. The heat transfer system of any previous sentence, wherein the soap comprises an ethanolamine carboxylate, where the fatty acid comprises a palmitic acid. The heat transfer system of any previous sentence, wherein the soap is present in the heat transfer fluid at an amount sufficient to achieve the desired freezing point/heat capacity needed for the environment of the heat transfer. The heat transfer system of any previous sentence, wherein the soap is present in the heat transfer fluid at from about 0.01 to about 15 wt % based on the weight of the heat transfer fluid. The heat transfer system of any previous sentence, wherein the soap is present in the heat transfer fluid at from about 0.05 to about 12 wt %. The heat transfer system of any previous sentence, wherein the soap is present in the heat transfer fluid at from about 0.1 to about 10 wt %. The heat transfer system of any previous sentence, wherein the soap is present in the heat transfer fluid at from about 0.5 to about 5 wt %. The heat transfer system of any previous sentence, wherein the soap is present in the heat transfer fluid at from about 1 to about 4 wt %. The heat transfer system of any previous sentence, wherein the heat transfer fluid further comprises a corrosion inhibitor. The heat transfer system of any previous sentence, wherein the corrosion inhibitor is present at from about 0.01% to about 6.0% or from 0.02%, 0.03%, 0.05%, 0.1% to 6%, 4%, 2%, 1% or even 0.5%. The heat transfer system of any previous sentence, wherein the heat transfer fluid further comprises an antioxidant. The heat transfer system of any previous sentence, wherein the antioxidant is present at from about 0.01% to about 6.0%, or from 0.02%, 0.03%, 0.05%, 0.1% to 6%, 4%, 2%, 1% or even 0.5%. A method of dispersing heat from electrical componentry comprising, (a) providing a heat transfer system in close contact with the electrical componentry, (b) circulating through said heat transfer system a heat transfer fluid as set forth in any previous sentence, and operating the electrical componentry and the heat transfer system. The method of the previous sentence, wherein the electrical componentry comprises a battery module, and operating the battery module comprises charging the battery module such that at least 75% of the total battery module capacity is restored in a time period of less than 15 minutes.

What is claimed is:

1. A heat transfer system comprising
a. a heat transfer fluid comprising,
i. water,
ii. C₂-C₁₈ alkylene glycol, and
iii. a soap comprising at least one of a C₂-C₁₈ metal carboxylate, ethanolamine carboxylate, or mixtures thereof and
a. a circulation system for circulating the heat transfer fluid in close contact to electrical componentry.

2. The heat transfer system of claim 1, wherein the water is demineralized water.

3. The heat transfer system of claim 1, wherein the C₂ to C₁₈ alkylene glycol comprises ethylene glycol or propylene glycol.

4. The heat transfer system of claim 1, wherein the soap comprises disodium adipate or disodium succinate.

5. The heat transfer system of claim 1, wherein the heat transfer fluid further comprises a corrosion inhibitor.

6. The heat transfer system of claim 1, wherein the heat transfer fluid further comprises an antioxidant.

7. A method of dispersing heat from electrical componentry comprising,
a. providing a heat transfer system in close contact with the electrical componentry,
b. circulating through said heat transfer system a heat transfer fluid comprising,
i. water,
ii. C₂-C₁₈ alkylene glycol, and
iii. a soap comprising at least one of a C₂-C₁₈ metal carboxylate, ethanolamine carboxylate, or mixture thereof and
c. operating the electrical componentry and the heat transfer system.

8. The method of claim 7, wherein the electrical componentry comprises a battery module, and operating the battery module comprises charging the battery module such that at least 75% of the total battery module capacity is restored in a time period of less than 15 minutes.
